(19) United States
(12) Patent Application Publication
(10) Pub. No.: US 2015/0101568 A1
(43) Pub. Date: Apr. 16, 2015

(54) EXHAUST BREAK FOR HIGH TORQUE VEHICLE AND CONTROL METHOD THEREOF

(71) Applicant: Hyundai Motor Company, Seoul (KR)

(72) Inventor: Munkyum Kim, Hwaseong-Si (KR)

(73) Assignee: Hyundai Motor Company, Seoul (KR)

(21) Appl. No.: 14/103,776

(22) Filed: Dec. 11, 2013

(30) Foreign Application Priority Data
Oct. 11, 2013 (KR) 10-2013-0121151

(51) Int. Cl. F02D 13/04

(52) U.S. Cl. CPC F02D 13/04
USPC 123/323

(57) ABSTRACT

A control method of the exhaust brake for a high torque vehicle may include an exhaust pressure keeping logic which (a) detects the exhaust pressure within the exhaust pipe which is the exhaust gas discharge path of the engine, (b) divides the detected exhaust pressure size value into exhaust pressure Y1, exhaust pressure Y2, and exhaust pressure Y3, (c) classifies the high pressure air injection quantity into high pressure air injection quantity 1, high pressure air injection quantity 2, and high pressure air injection quantity 3 to meet the exhaust pressure divided into the exhaust pressure size value, (d) injects the classified high pressure air injection quantity into the inner space of the exhaust pipe, and (e) re-calculates the high pressure air injection quantity after the high pressure air injection.

### CROSS-REFERENCE TO RELATED APPLICATIONS

The present application claims priority of Korean Patent Application Number 10-2013-0121151 filed Oct. 11, 2013, the entire contents of which application is incorporated herein for all purposes by this reference.

### BACKGROUND OF INVENTION

1. Field of Invention

The present invention relates to an exhaust brake, and particularly, to an exhaust brake for a high torque vehicle kept to have optimal performance at all times by preventing an exhaust pressure from reducing even when a displacement volume is reduced due to a structural limitation of an exhaust brake valve and engine downsizing, and a control method thereof.

2. Description of Related Art

Generally, a large commercial vehicle may not obtain a sufficient braking force only by a foot brake which holds and constrains a wheel and therefore is further mounted with various auxiliary brakes.

The auxiliary brake is based on a method of further securing a braking force by reducing power transferred to a crank shaft in an intake-compression-exhaust stroke of a combustion stroke of an engine. An example of the auxiliary brake may include an engine brake, a Jake brake, and an exhaust brake.

Considering an engine brake among them, a valve is installed in a path through which exhaust gas of an engine combustion chamber is discharged, the exhaust pressure which increases by blocking the exhaust gas from being discharged to the air when the valve is closed increases a pressure of the engine combustion chamber, and in this state, a piston suffers from resistance at the time of the exhaust stroke to allow the high exhaust pressure to act as a resistance force to hinder an engine cylinder motion, thereby obtaining the braking effect.

Therefore, it is most important for the exhaust brake to form the sufficient exhaust pressure when the valve is closed.

However, the exhaust brake may have the reduced performance due to the structural limitation of the valve.

For example, as the valve a butterfly type valve is used. In this case, the butterfly type valve needs to return the butterfly to its own initial position, such that a clearance (gap) between the butterfly and the valve body may be present.

The clearance (gap) forms a path through which the exhaust gas which is an energy source of the braking force is discharged, which is one factor of preventing the exhaust pressure from sufficiently increasing at the time of an operation of the exhaust brake. When an emission quantity of the exhaust gas discharged through the clearance (gap) is large, performance of the exhaust brake may be largely reduced even through the exhaust brake is operated.

Further, the exhaust brake uses the exhaust gas and thus the reduction in performance of the exhaust brake due to an engine output state may occur.

For example, when the engine RPM is in a low speed/middle speed section, the displacement volume is reduced, such that the reduction in performance of the exhaust brake may occur at the time of low speed/middle speed, and when the engine RPM is in a high speed but a low load condition, the displacement volume is reduced, such that the reduction in performance of the exhaust brake may occur at the time of the high speed/engine low load.

In particular, in an engine for a commercial vehicle which has high horse power and high torque but is downsized due to regulation of exhaust and has improved fuel efficiency, the displacement volume is more reduced due to minimization/optimization of an intake air quantity, such that the reduction in performance of the exhaust brake may be more severed.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an exhaust brake for a high torque vehicle capable of optimally keeping performance of exhaust brake at all times by forming a sufficient exhaust pressure even in an engine for a commercial vehicle which overcomes a structural limitation of an exhaust brake applied with a butterfly valve by increasing an exhaust pressure when the exhaust pressure is insufficiently formed at the time of operating the exhaust brake, in particular, which is downsized due to regulation of exhaust and improvement in fuel efficiency and has high horse power and high torque and a reduced displacement volume, and a control method thereof.

Various aspects of the present invention provide for a control method of an exhaust brake for a high torque vehicle that includes: an exhaust pressure keeping logic configured to be perform during an operation of the exhaust brake when the operation of the exhaust brake is performed by turning on a switch of the exhaust brake, wherein the exhaust pressure keeping logic (a) detects the exhaust pressure within an exhaust pipe which is an exhaust gas discharge path of the engine, (b) divides a size value of the detected exhaust pressure into exhaust pressure Y1, exhaust pressure Y2, and exhaust pressure Y3, (c) classifies a high pressure air injection quantity into high pressure air injection quantity 1, high pressure air injection quantity 2, and high pressure air injection quantity 3 to meet the exhaust pressure divided into the size value of the exhaust pressure, (d) injects the classified high pressure air injection quantity into an inner space of the exhaust pipe, and (e) re-calculates the high pressure air injection quantity after the high pressure air injection.

The size value of the detected exhaust pressure may be a value smaller than an exhaust pressure set to operate the exhaust brake and may be divided into exhaust pressure Y1>exhaust pressure Y2>exhaust pressure Y3, exhaust pressure Y1=high pressure air injection quantity 1, the exhaust pressure Y2=high pressure air injection quantity 2, and exhaust pressure Y3=high pressure air injection quantity 3. The high pressure air injection quantities 1, 2, and 3 may be divided into high pressure air injection quantity 1<high pressure air injection quantity 2<high pressure air injection quantity 3.

The high pressure air may be high pressure air which is supplied to a butterfly valve of the exhaust brake. The re-calculation of the high pressure air injection quantity may be performed by detecting the exhaust pressure formed within the exhaust pipe after the high pressure air injection.

The exhaust pressure keeping logic may stop the high pressure air injection at the time of turning off the exhaust brake switch.

Various aspects of the present invention provide for an exhaust brake for a high torque vehicle that includes: an exhaust brake lever configured to be turned on/off; a solenoid valve configured to be operated by a turn on/off signal of the exhaust brake lever; a butterfly valve configured to block a path of the exhaust pipe connected to an engine by high pressure air supplied from a high pressure tank at the time of an operation of the solenoid valve; an exhaust pressure sensor configured to detect the exhaust pressure of the exhaust pipe; a high pressure injector configured to inject the high pressure air of the high pressure tank to an inner space of the exhaust pipe; and an engine control unit (ECU) configured to further execute an exhaust pressure keeping logic which divides a size value of the exhaust pressure of the exhaust pipe detected by the exhaust pressure sensor into at least three steps and injects the high pressure air of the high pressure tank into the inner space of the exhaust pipe to allow a high pressure air injection quantity of the high pressure injector to meet the size value of the three step exhaust pressure.

The exhaust pressure sensor and the high pressure injector each may be directly mounted in the exhaust pipe.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an exemplary exhaust brake for a high torque vehicle in accordance with the present invention.

FIG. 2 is an operation flow diagram of an exemplary exhaust brake logic including an exhaust pressure keeping function of constantly keeping an exhaust pressure in the exhaust brake for a high torque vehicle in accordance with the present invention.

FIG. 3 is a diagram illustrating an operation initial state of an exemplary exhaust brake for a high torque vehicle in accordance with the present invention.

FIG. 4 is a diagram illustrating a state in which the operation of the exhaust brake for a high torque vehicle is optimally kept by supplementing the reduction in exhaust pressure at the time of the operation of FIG. 3.

FIG. 5 is an exhaust pressure diagram of a constant pressure depending on a result of FIG. 4.

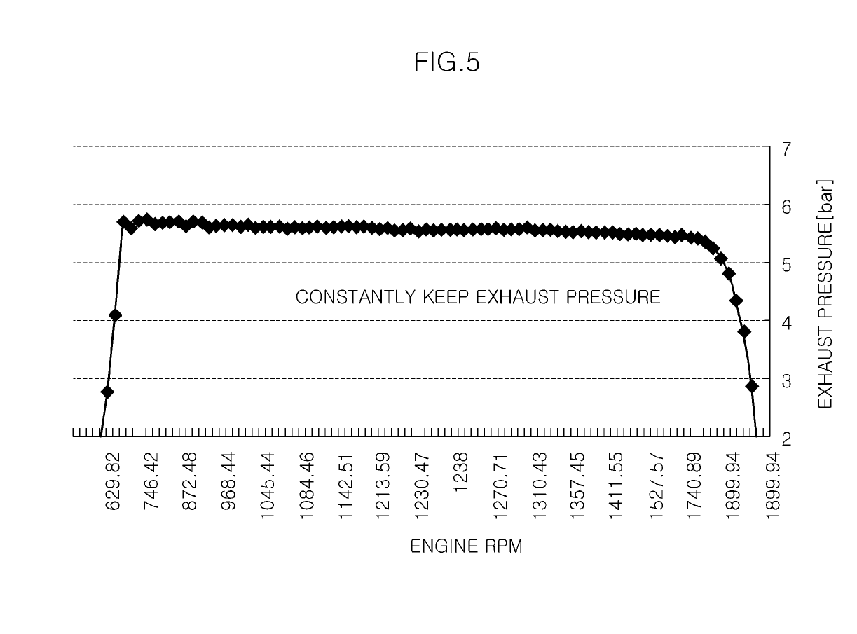

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the disclosure, like reference numerals refer to like parts throughout the various figures and various embodiments of the present invention.

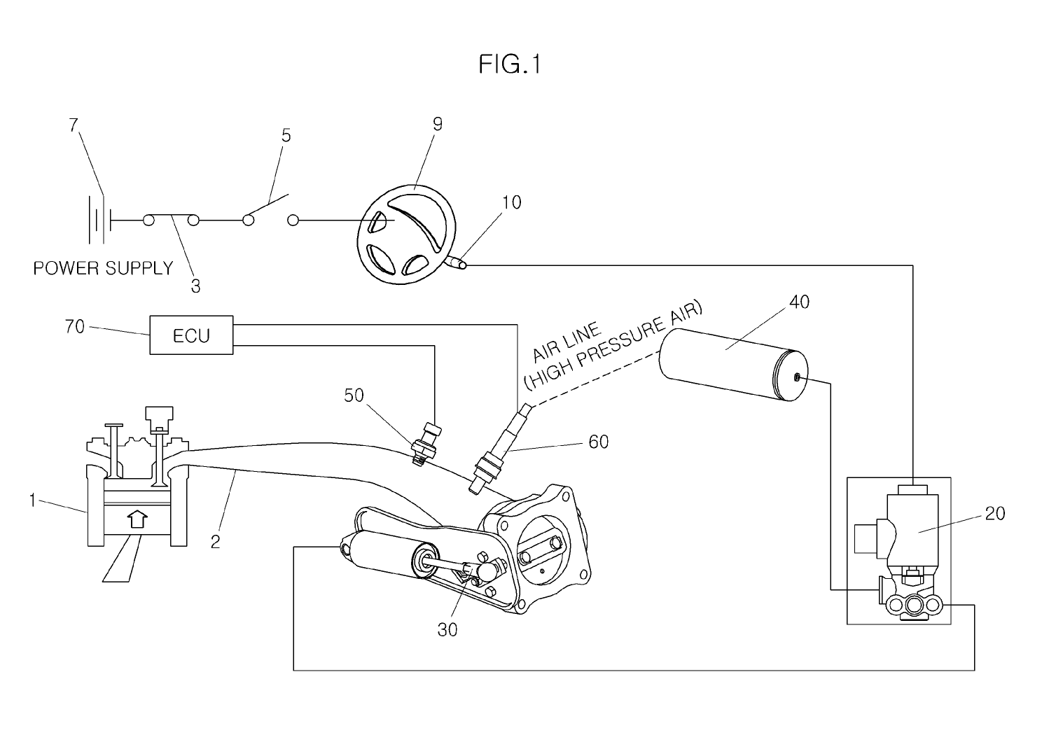

FIG. 1 illustrates an exhaust brake for a high torque vehicle in accordance with various embodiments of the present invention.

As illustrated in FIG. 1, the exhaust brake is configured to include an exhaust brake lever 10 which is disposed at a steering wheel 9, a solenoid valve 20 operated by a signal of the exhaust brake lever 10, a butterfly valve 30 which is closed by a high pressure of a high pressure tank 40 at the time of an operation of the solenoid valve 20 to block a path of the exhaust pipe 2 connected to the engine 1, an exhaust pressure sensor 50 which detects an exhaust pressure of the exhaust pipe 2 and transmits the detected exhaust pressure to an engine control unit (ECU) 70, and a high pressure injector 60 which injects the high pressure of the high pressure tank 40 to the exhaust pipe 2 by a control of the ECU 70.

The exhaust brake lever 10 supplies power of a battery 7 to the solenoid valve 20 under a condition of a turn on of the clutch 3 and a turn off of an accelerator pedal 5 at the time of the operation of the exhaust brake lever 10 by electrically connecting the clutch 3 with the accelerator pedal 5 and the battery 7.

Therefore, when the power of the battery 7 is supplied to the solenoid valve 20, the solenoid valve 20 is opened, such that an air flow path of the high pressure tank 40 and the butterfly valve 30 may be opened. However, the solenoid valve 20 may be operated reversely.

The exhaust pressure sensor 50 and the high pressure injector 60 are directly mounted at the exhaust pipe 2.

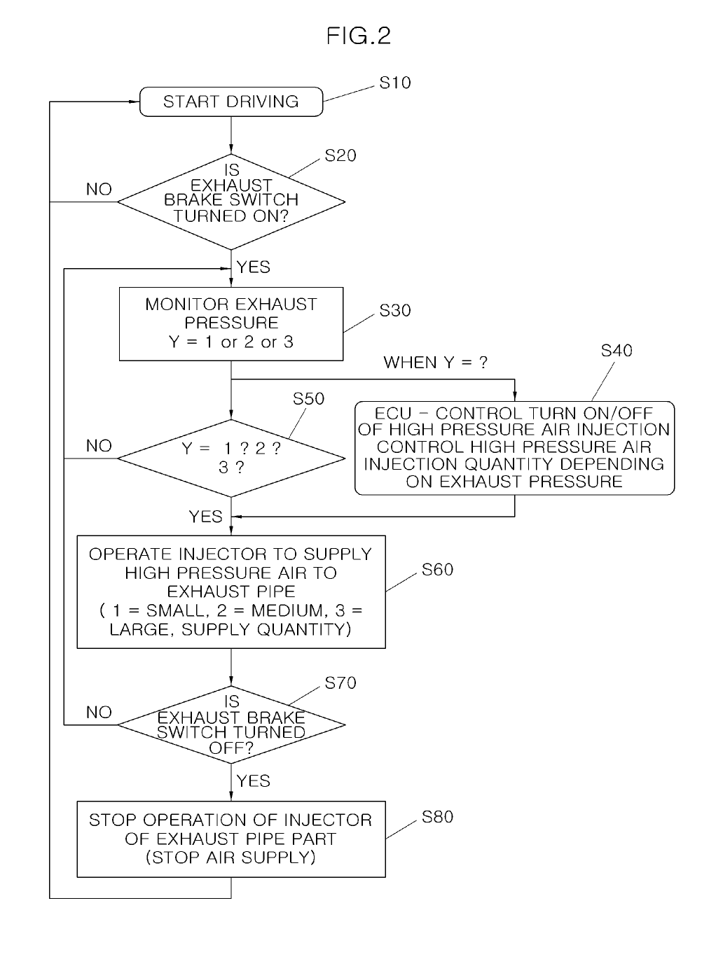

Meanwhile, FIG. 2 illustrates an operation flow of an exhaust brake logic including an exhaust pressure keeping function of constantly keeping an exhaust pressure in the exhaust brake for a high torque vehicle in accordance with various embodiments of the present invention.

In a vehicle driving state of S10, when the exhaust brake switch is changed to a turn on as in S20, the exhaust pressure monitoring is performed as in S30 and thus a value of the exhaust pressure at the time of the operation of the exhaust brake is checked. An exhaust pressure Y of S30 is defined as an operation exhaust pressure Y? of the exhaust brake. In this case, the operation initial exhaust pressure Y? of the exhaust brake may be an exhaust pressure suitable for the exhaust brake operation or may be an exhaust pressure which is not suitable for the exhaust brake operation.

Therefore, the operation initial exhaust pressure Y? of the exhaust brake may be checked with any one of Y (exhaust pressure)=1 or Y (exhaust pressure)=2 or Y (exhaust pressure)=3 and in each of the checked Y=1, 2, and 3, the high pressure air injection of the injector is performed, such that the operation initial exhaust pressure Y? of the exhaust brake may have an exhaust pressure suitable for the operation of the exhaust brake.

In this case, Y=1, Y=2, and Y=3 are values smaller than the exhaust pressure set to operate the exhaust brake, and they are divided into Y=1>Y=2>Y=3.

S40 is a step of performing a control by applying the operation initial exhaust pressure Y? of the exhaust brake after the check of S30, while S50 is a step of determining whether the state of the Y (exhaust pressure) after the checking of S30 is any one of Y=1, Y=2, and Y=3.

Therefore, at S40, the operation of the exhaust brake is performed in the state of the operation initial exhaust pressure Y? of the exhaust brake checked at S30 and the high pressure air injection of the injector is performed depending on the size of the operation initial exhaust pressure Y? of the exhaust brake. Therefore, the exhaust brake operated under the condition of the operation initial exhaust pressure Y? of the exhaust brake may perform the high pressure air injection using the injector and may not be performed.

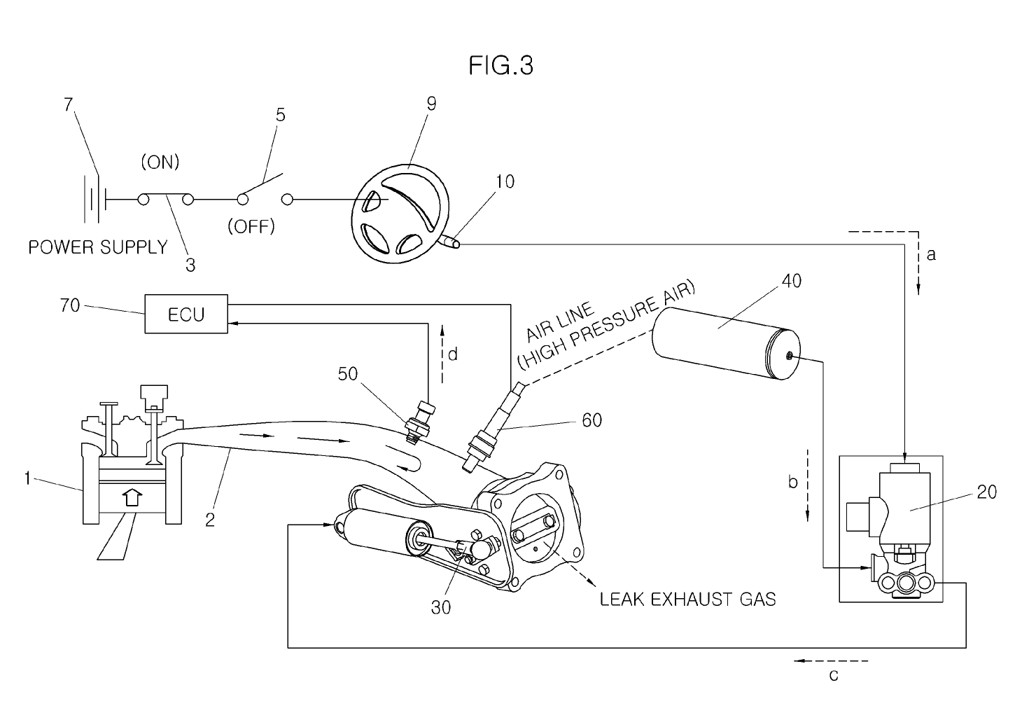

The state may be appreciated from the operation initial state of the exhaust brake for a high torque vehicle illustrated in FIG. 3. As illustrated in FIG. 3, when the exhaust brake lever 10 is operated in the condition of the turn on of the clutch 3 and the turn off of the accelerator pedal 5, the switch of the exhaust brake lever 10 forms a power supply circuit a between the battery 7 and the solenoid valve 20 to change the solenoid valve to the turn on.

The operation of the solenoid valve 20 opens a high pressure path b of the solenoid valve 20 and the high pressure tank 40 and at the same time, opens a high pressure path c of the solenoid valve 20 and the butterfly valve 30, such that the high pressure air of the high pressure tank 40 is introduced into the butterfly valve 30.

Next, the butterfly valve 30 is closed to block the path of the exhaust pipe 2, thereby blocking the discharge of the exhaust gas. Therefore, the exhaust pressure is increased between the engine 1 and the exhaust pipe 2 to operate the engine brake.

When the engine brake is operated, the exhaust pressure within the exhaust pipe 2 is the operation initial exhaust pressure Y? of the exhaust brake, which means the exhaust pressure within the exhaust pipe 2 which is detected by the exhaust pressure sensor 50 transmitting a detection signal d to the ECU 70.

In this case, the high pressure injector 60 does not perform the high pressure air injection to the exhaust pipe 2, which means that the operation initial exhaust pressure Y? of the exhaust brake does not bring the reduction on performance of the exhaust brake. However, when the operation initial exhaust pressure Y? of the exhaust brake brings the reduction in performance of the exhaust brake, the high pressure injector 60 performs the high pressure air injection to the exhaust pipe 2. The case will be described below.

Referring again to FIG. 2, at S50, it is determined whether the change in the operation initial exhaust pressure Y(Y?) of the exhaust brake after the checking of S30 is any one of Y=1, Y=2, and Y=3. Therefore, even though the exhaust brake is operated under the condition of the operation initial exhaust pressure Y? of the exhaust brake, the operation may be performed in the optimum exhaust pressure state during the operation of the exhaust brake.

S60 is a step of operating the high pressure injector by defining the exhaust pressure as any one of Y=1, Y=2, and Y=3, such that the high pressure injector injects the high pressure air to the exhaust pipe. For example, when Y=1, the injector injection quantity 1 is defined as small, when Y=2, the injector injection quantity 2 is defined as medium, and when y=3, the injector injection quantity 3 is defined as large.

The state is an exhaust pressure keeping state, which is referred to as an exhaust pressure keeping logic.

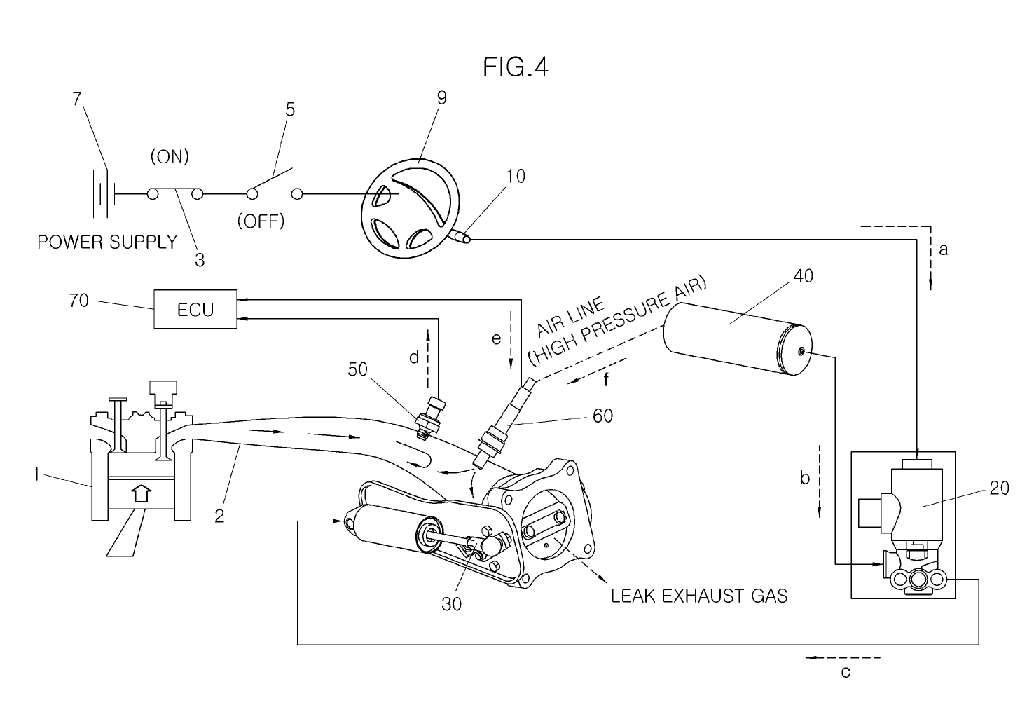

The state may be appreciated from the exhaust pressure reduction supplement state of the exhaust brake for a high torque vehicle illustrated in FIG. 4. As illustrated in FIG. 4, the ECU 70 checks the exhaust pressure state within the exhaust pipe 2 from the detection signal d of the exhaust pressure sensor 50, such that the exhaust pressure may be checked with any one of Y=1, Y=2, and Y=3 in the operation state of the exhaust brake. In this case, it is assumed that the exhaust pressure checked by the ECU 70 is Y=3.

Next, the ECU 70 defines the high pressure air injection quantity of the high pressure injector 60 as the injector injection quantity 3=large which matches Y=3 and then transmits an output signal e to the high pressure injector 60.

Next, the high pressure injector 60 directly injects the high pressure air of the high pressure tank 40 into the exhaust pipe 2, such that the exhaust pressure of the inner space of the exhaust pipe 2 is increased by the high pressure air.

During the process, the ECU 70 continuously checks the detection signal d of the exhaust pressure sensor 50 to check the time when the high pressure air injection of the high pressure injector 60 stops or the injection quantity is controlled. Therefore, the exhaust pressure of the exhaust pipe 2 may be kept at a constant exhaust pressure state at which the optimal performance of the exhaust brake is kept at all times. The constant exhaust pressure keeping of the exhaust pipe 2 is verified in the experiment diagram of FIG. 4.

Referring again to FIG. 2, after it is checked whether the exhaust brake switch is changed to the turn off at S70, the process is fed back to S30 when the exhaust brake switch is kept in the turn on state, and thus the execution of the exhaust pressure keeping logic is continued.

On the other hand, when the turn off of the exhaust brake switch is checked by the check of S70, the process enters S80 to stop the high pressure air injection of the high pressure injector and the exhaust brake control logic enters a standby mode.

As described above, the control method of the exhaust brake for a high torque vehicle in accordance with various embodiments of the present invention includes the exhaust pressure keeping logic which (a) detects the exhaust pressure within the exhaust pipe which is the exhaust gas discharge path of the engine, (b) divides a size value of the detected exhaust pressure into exhaust pressure Y1, exhaust pressure Y2, and exhaust pressure Y3, (c) classifies the high pressure air injection quantity into high pressure air injection quantity 1, high pressure air injection quantity 2, and high pressure air injection quantity 3 to meet the exhaust pressure divided into the size value of the exhaust pressure, (d) injects the classified high pressure air injection quantity into the inner space of the exhaust pipe, and (e) re-calculates the high pressure air injection quantity after the high pressure air injection, thereby increasing the exhaust pressure when the exhaust pressure is insufficiently formed at the time of the operation of the exhaust brake to overcome the structural limitation of the exhaust brake applied with the butterfly valve, in particular, forming the sufficient exhaust pressure even in the engine for the commercial vehicle which is downsized due to the regulation of exhaust and the improvement in fuel efficiency and has the high horse power and the high torque and the reduced displacement volume to optimally keep the performance of the exhaust brake at all times.

In accordance with various embodiments of the present invention, the performance of the exhaust brake may be optimized by keeping the exhaust pressure at the optimal condition at all times at the time of the operation of the exhaust brake, in particular, the structural limitation of the butterfly valve may be overcome even in the exhaust brake applied with the butterfly valve which may cause the leakage of exhaust gas.

Further, in accordance with various embodiments of the present invention, the performance of the exhaust brake may be optimally implemented without changing the exhaust brake applied with the butterfly valve, such that the previously used exhaust brake may be also used without changing the specification or performance of the butterfly valve.

In addition, in accordance with various embodiments of the present invention, even in the low speed/middle speed section in which the displacement volume of the engine or the high speed/engine low load, the optimal exhaust pressure may be kept at all times, such that the performance of the exhaust brake may be optimized, in particular, the field claim due to the reduction in performance of the exhaust brake may not occur.

Moreover, in accordance with various embodiments of the present invention, the exhaust pressure may be optimally kept at the time of the operation of the exhaust brake even in the engine for the commercial vehicle which is downsized due to the regulation of exhaust and the improvement in fuel efficiency and has the high horse power and high torque and the reduced displacement volume.

Also, in accordance with various embodiments of the present invention, the performance of the exhaust brake may be optimally kept at all times to reduce the frequent main braking operation using the foot brake, thereby reducing the consumption of the friction material and preventing the fade phenomenon, in particular, previously preventing the safety accident such as the damage of the tire due to the heat generation of the drum brake.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method of an exhaust brake for a high torque vehicle comprising:
performing an exhaust pressure keeping logic with a engine control unit (ECU) during an operation of the exhaust brake when the operation of the exhaust brake is performed by turning on a switch of the exhaust brake;
wherein the exhaust pressure keeping logic (a) detects the exhaust pressure value within an exhaust pipe which is an exhaust gas discharge path of the engine, (b) decides a high pressure air injection quantity to meet the detected exhaust pressure value, (c) injects the decided high pressure air injection quantity into an inner space of the exhaust pipe, and (d) re-calculates the high pressure air injection quantity after the high pressure air injection.

2. The control method of claim 1, wherein the detected exhaust pressure value divides a size value of the detected exhaust pressure into exhaust pressure Y1, exhaust pressure Y2, and exhaust pressure Y3; and
wherein the decided high pressure air injection quantity classifies a high pressure air injection quantity into high pressure air injection quantity 1, high pressure air injection quantity 2, and high pressure air injection quantity 3.

3. The control method of claim 2, wherein the size value of the detected exhaust pressure is a value smaller than an exhaust pressure set to operate the exhaust brake and is divided into exhaust pressure Y1>exhaust pressure Y2>exhaust pressure Y3.

4. The control method of claim 3, wherein exhaust pressure Y1=high pressure air injection quantity 1, the exhaust pressure Y2=high pressure air injection quantity 2, and exhaust pressure Y3=high pressure air injection quantity 3.

5. The control method of claim 4, wherein the high pressure air injection quantities 1, 2, and 3 are divided into high pressure air injection quantity 1<high pressure air injection quantity 2<high pressure air injection quantity 3.

6. The control method of claim 1, wherein the high pressure air is high pressure air which is supplied to a butterfly valve of the exhaust brake.

7. The control method of claim 1, wherein the re-calculation of the high pressure air injection quantity is performed by detecting the exhaust pressure formed within the exhaust pipe after the high pressure air injection.

8. The control method of claim 1, wherein the exhaust pressure keeping logic stops the high pressure air injection at the time of turning off the exhaust brake switch.

9. An exhaust brake for a high torque vehicle, comprising:
an exhaust brake lever configured to be turned on and off;
a solenoid valve configured to be operated by a turn on/off signal of the exhaust brake lever;
a butterfly valve configured to block a path of the exhaust pipe connected to an engine by high pressure air supplied from a high pressure tank at the time of an operation of the solenoid valve;
an exhaust pressure sensor configured to detect the exhaust pressure of the exhaust pipe;
a high pressure injector configured to inject the high pressure air of the high pressure tank to an inner space of the exhaust pipe; and
an engine control unit (ECU) configured to further execute an exhaust pressure keeping logic which divides a size value of the exhaust pressure of the exhaust pipe detected by the exhaust pressure sensor into at least three steps and injects the high pressure air of the high pressure tank into the inner space of the exhaust pipe to allow a high pressure air injection quantity of the high pressure injector to meet the size value of the three step exhaust pressure.

10. The exhaust brake of claim 9, wherein the exhaust pressure sensor and the high pressure injector each are directly mounted in the exhaust pipe.
